(19) United States
(12) Patent Application Publication
(10) Pub. No.: US 2015/0161322 A1
(43) Pub. Date: Jun. 11, 2015

(54) DESIGN SUPPORT APPARATUS AND METHOD

(71) Applicant: FUJITSU LIMITED, Kawasaki-shi (JP)

(72) Inventor: Hironobu YOSHINO, Shinjuku (JP)

(21) Appl. No.: 14/537,937

(22) Filed: Nov. 11, 2014

(30) Foreign Application Priority Data
Dec. 9, 2013 (JP) 2013-254516

(51) Int. Cl. G06F 17/50

(52) U.S. Cl. CPC G06F 17/5081; G06F 2217/82

(57) ABSTRACT

A design support apparatus searches, by using back tracing, for combination of input signals, to be input to an analysis circuit, that causes transition of a level of a signal in an aggressor wire by switching a level of one input signal among input signals that determine a level of a signal in the aggressor wire. The design support apparatus calculates a delay time of a transition path connecting an input terminal of the analysis circuit and an output terminal connected to the aggressor wire. Also, the design support apparatus generates an input vector for shifting, by the delay time, switching of a level of an input signal to be input to a first transition path connected to a first aggressor wire included in the analysis circuit in such a manner that the levels of the signals in the first aggressor wire and a second aggressor wire transition simultaneously.

### CROSS-REFERENCE TO RELATED APPLICATION

This application is based upon and claims the benefit of priority of the prior Japanese Patent Application No. 2013-254516, filed on Dec. 9, 2013, the entire contents of which are incorporated herein by reference.

### FIELD

The embodiments discussed herein are related to a technique of analyzing noise.

### BACKGROUND

In semiconductor tests, analysis is conducted on crosstalk noise, which is caused by the influence of coupling capacity for coupling wires in an integrated circuit. In analysis of crosstalk noise, a design support apparatus causes transition of the levels of signals 111 and 112 in aggressor wires (agg0 and agg1), which are affecting a crosstalk-detection-target victim wire (vic), as illustrated in FIG. 1, for example. The design support apparatus detects as crosstalk noise 113 changes in the levels of signals caused in the victimwire. Then, the user analyzes the magnitude or the propagation of the crosstalk noise 113 detected by the design support apparatus so as to verify the noise tolerance of the integrated circuit. Note that vic is an abbreviation for victim and agg is an abbreviation for aggressor. In the explanations below, a coupling capacity is also referred to as capacity coupling. Also, crosstalk noise is also referred to as noise. Detecting crosstalk noise to analyze the propagation of the crosstalk noise 113 is also referred to as crosstalk noise analysis.

As another related technique, according to a testing method of a semiconductor integrated circuit, a net list that fulfills logical functions is input, a scan path test structure is generated and master pattern layout is conducted on the input net list. Also, in the testing method of a semiconductor integrated circuit, a risky portion, where influence of crosstalk is highly likely to emerge in a mask pattern layout, is extracted. Also, in the testing method of a semiconductor circuit, a testing circuit is added in order to use a gate delay ATPG to generate a test pattern that causes influence of crosstalk to emerge in the extracted risky portion. Thereby, in the testing method of a semiconductor integrated circuit, a manufacturing test is performed by using a test pattern generated by using a gate delay ATPG in a circuit to which a test circuit has been added. Note that ATPG is an abbreviation for automatic test pattern generator.

Also, as another related technique, a semiconductor integrated circuit includes a ring oscillator having a plurality of inverters connected in series to form an odd number of stages and a first wiring AGG that is provided along a wiring VIC, which is part of the ring oscillator. Further, the semiconductor integrated circuit includes a pulse generation circuit that generates a first pulse to be supplied to the first wiring AGG, a first buffer connected between the first wiring AGG and the pulse generation circuit, and a second wire connected between the pulse generation circuit and the first buffer. Also, the distance between the first wiring AGG and the wiring VIC, which is part of the ring oscillator RO, is made shorter than the distance between the second wire and the wiring VIC, which is part of the ring oscillator RO.

Also, as another related technique, according to a crosstalk verification method, glitch arrival timing obtained from a timing constraint assigned to a semiconductor integrated circuit and from a delay calculation result is detected. According to this crosstalk verification method, clock input timing for a synchronous circuit element is detected. According to this crosstalk verification method, glitch information of a glitch that arrives at a net connected to a data input terminal of a synchronous circuit element is obtained. According to this crosstalk verification method, glitch information, glitch arrival timing and clock input timing are used so as to determine whether or not a glitch that arrives at the net connected to the data input terminal of the synchronous circuit element will cause a malfunction (for example, Japanese Laid-open Patent Publication No. 2001-305191, Japanese Laid-open Patent Publication No. 2005-116994 and Japanese Laid-open Patent Publication No. 2007-86950).

According to the analysis techniques described above, it is required in some cases for example that the transition of the levels of signals in a plurality of aggressor wires be caused simultaneously in order to detect the worst value of the crosstalk noise in crosstalk noise analysis. However, in the design support apparatus of the analysis technique described above, because paths connecting the input terminal of the analysis-target circuit and respective aggressor wires have different delay times, it is impossible, as illustrated in FIG. 2, to cause transition of the levels of signals in a plurality of aggressor wires, which is problematic.

### SUMMARY

According to an aspect of the embodiments, a design support apparatus includes a processor. The processor searches, by using back tracing, for a combination of input signals, to be input to an analysis circuit, that causes transition of a level of a signal in an aggressor wire by switching a level of one input signal among input signals that determine a level of a signal in the aggressor wire influencing a victim wire that is a noise analysis target. The processor calculates a delay time of a transition path connecting an input terminal of the analysis circuit to which an input signal to be switched is to be input and an output terminal connected to the aggressor wire. The processor generates an input vector for shifting, by a difference of a calculated delay time, switching of a level of an input signal to be input to a first transition path connected to a first aggressor wire or to a second transition path connected to a second aggressor wire included in the analysis circuit in such a manner that the levels of the signals in the first aggressor wire and the second aggressor wire transition simultaneously.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the occurrence of crosstalk noise;

FIG. 2 illustrates a timing difference in transition between signals in aggressor wires;

FIG. 3 illustrates dependence relationships of the magnitudes of crosstalk noise;

FIG. 4 illustrates relationships between input signals of a cluster and signal states in aggressor wires;

FIG. 5 illustrates generation of an input pattern used for detecting a stuck-at fault;

FIG. 6 is a functional block diagram illustrating an example of a design support apparatus;

FIG. 7 illustrates an example of a net list;

FIG. 8 illustrates examples of partial circuits;

FIG. 9 illustrates an example of an analysis circuit;

FIG. 10 illustrates generation of an input vector that has taken transition of signal levels into consideration;

FIG. 11 illustrates 0/1 conversion rules of a node;

FIG. 12 illustrates open/close conversion rules of a stack;

FIG. 13 illustrates rise/fall conversion rules of a node;

FIG. 14 illustrates rise/fall conversion rules of a stack;

FIG. 15 illustrates conditions of back tracing that has taken transition signals into consideration;

FIG. 16 illustrates an example of aggressor wires for which signal levels are not able to transition simultaneously;

FIG. 17 illustrates shifting of timings of inputting transition signals;

FIG. 18 is a flowchart explaining a generation process of an input vector; and

FIG. 19 is a block diagram illustrating an example of a computer apparatus.

### DESCRIPTION OF EMBODIMENTS

Explanations will be given for a design support apparatus according to an embodiment.

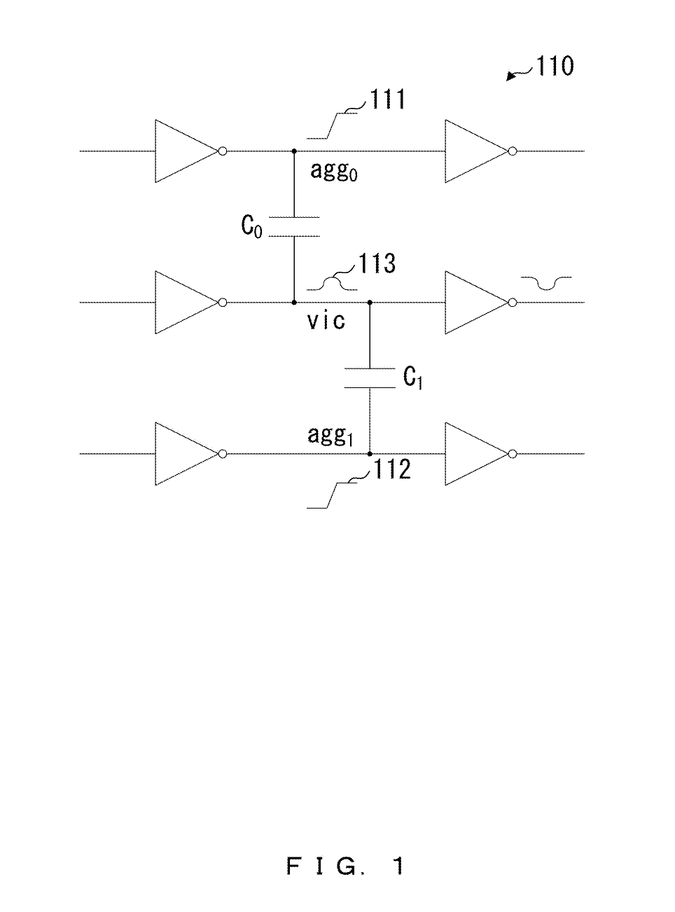

Problems in the analysis of crosstalk noise will be explained by referring to FIG. 1 through FIG. 5.

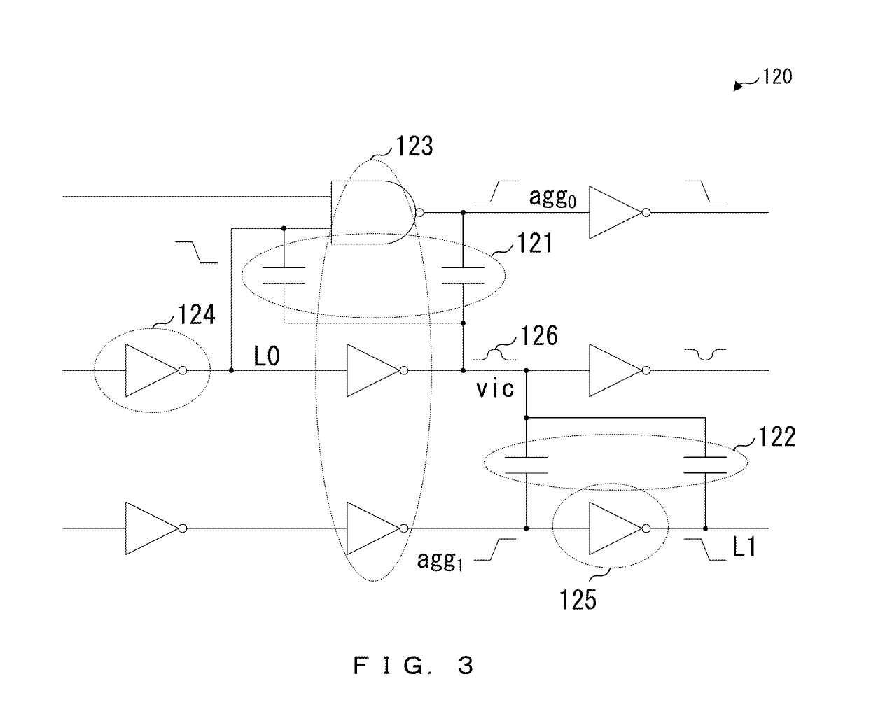

FIG. 3 illustrates dependence relationships of the magnitude of crosstalk noise.

The magnitude of crosstalk noise occurring in a victim wire depends upon the magnitude of resistance of a victim wire and an aggressor wire, the magnitude of the capacity coupling between a victim wire or an aggressor wire, the level of the drivability of an element that outputs signals to a victim wire and an aggressor wire, and upon other factors.

When for example an element includes a field-effect transistor, the shorter the switching times of the field-effect transistor, i.e., the rise time and the fall time, are, the higher the drivability level is. Also, the shorter the switching time of a field-effect transistor included in an element is, the more sharply signals change in wires in a circuit, leading to abrupt changes in energy accumulated in the capacity coupling and leading to a greater magnitude of crosstalk noise occurring in a victim wire. In other words, the higher the drivability level of a field-effect transistor is, the higher the magnitude of crosstalk noise tends to be. In the explanations below, a field-effect transistor is also referred to as a MOS transistor (MOSFET) or simply a transistor. MOSFET is an abbreviation for metal oxide semiconductor field effect transistor.

Also, victim wire vic is affected by the capacity coupling occurring between the wires L0 and L1, which are in earlier and subsequent stages, in addition to the capacity coupling occurring between aggressor wires agg0 and agg1 adjacent to victim wire vic. In other words, the magnitude of crosstalk noise 126 occurring in victim wire vic depends upon the magnitudes of a capacity coupling 121 and a capacity coupling 122 occurring between victim wire vic and aggressor wires agg0 and agg1 or adjacent wires L0 and L1. Also, the magnitudes of influence of the capacity coupling 121 and the capacity coupling 122 on victim wire vic depend upon the drivability levels of elements 123 through 125.

Accordingly, when a signal for analyzing crosstalk noise is directly input to aggressor wires agg0 and agg1 in the analysis of crosstalk noise, influence from wires other than the aggressor wires is not taken into consideration, sometimes leading to insufficient accuracy in the analysis of crosstalk noise.

In view of the above, in order to increase accuracy in the analysis of crosstalk noise occurring in victim wire vic, it may be possible to treat as a cluster a circuit including a plurality of wires coupled with victim wire vic by means of capacity coupling and to analyze crosstalk noise. “A plurality of wires” refers to, for example, aggressor wires agg0 and agg1, wires L0 and L1 in the earlier and subsequent stages, etc. in FIG. 3. In the explanations hereinafter, a cluster is also referred to as an analysis circuit.

Also, in order to increase accuracy in the analysis of crosstalk noise, an input signal for causing transition of the levels of the signals in the aggressor wires is input through the input terminal of the analysis circuit. Thereby, an input signal input through the input terminal of a cluster propagates through a path included in the cluster so as to be output to the aggressor wires. The design support apparatus measures changes in a signal generated in a victim wire when the signal has been output to aggressor wires, and thereby can detect crosstalk noise while taking into consideration the influence of a plurality of wires and a plurality of elements included in the path.

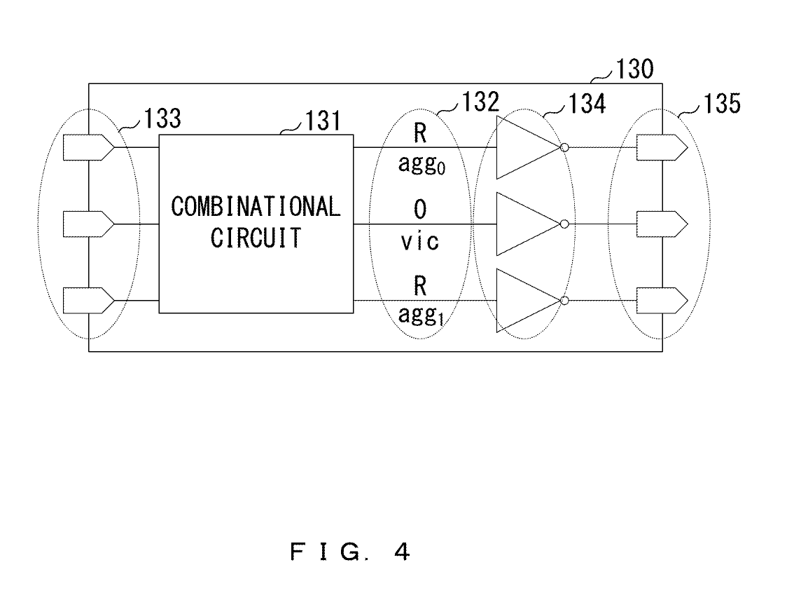

Accordingly, as illustrated in FIG. 4, the design support apparatus sets output patterns for crosstalk analysis for victim wire vic and aggressor wires agg0 and agg1, which are outputs of a combinational circuit 131 included in an analysis circuit 130, and obtains input patterns that accord with the set output patterns. An output pattern is a combination of output signals of a victim wire and a plurality of aggressor wires.

When performing crosstalk analysis, the design support apparatus inputs the obtained input pattern to an input terminal 133 and detects crosstalk noise occurring in victim wire vic. An input pattern is a combination of input signals to be input to the input terminal 133 of the analysis circuit 130. The combinational circuit 131 is a circuit including a path laid between the input terminal 133 of the analysis circuit 130 and a terminal connected to an analysis wire 132. Note that an element 134 between the analysis wire 132 and an output terminal 135 and a subsequent-stage wire are connected in order to take influence of the element 134 and a subsequent-stage wire into consideration in the analysis of crosstalk noise.

In FIG. 4, rising signal R has been set for aggressor wires agg0 and agg1. Rising signal R is a signal state that represents transition of a signal level from zero to one. Accordingly, when the design support apparatus has set rising signal R for aggressor wires agg0 and agg1, the design support apparatus obtains at least two input patterns: an input pattern 1 for changing the signal levels of aggressor wires agg0 and agg1 to zero and an input pattern 2 for changing those signal level to one. Also, the design support apparatus switches the input pattern from input pattern 1 to input pattern 2 and inputs the pattern to the input terminal 133 of the analysis circuit 130, and thereby can output rising signal R to aggressor wires agg0 and agg1. A signal level being zero means that the signal is in a low-level state. A signal level being one means that the signal is in a high-level state.

When performing crosstalk noise analysis, the design support apparatus switches an input signal to be input to the input terminal 133 from input pattern 0 to input pattern 1, and causes transition of the levels of the signals in aggressor wires agg0 and agg1 from zero to one. Also, the design support apparatus fixes victim wire vic at zero, measures changes in a signal occurring in victim wire vic when transition was caused in the levels of the signals in aggressor wires agg0 and agg1 from zero to one, and thereby detects crosstalk noise. Note that the purpose of inputting rising signal R to aggressor wires agg0 and agg1 with the level of a signal in victim wire vic fixed at zero so as to detect crosstalk noise is to analyze the possibility that the level of a signal in victim wire vic will be wrongly taken as 1 through the influence of crosstalk noise.

Explanations will further be given for a case where falling signal F has been set for aggressor wires agg0 and agg 1 in FIG. 4. Falling signal F represents transition of a signal level from one to zero.

Accordingly, when performing crosstalk noise analysis, the design support apparatus switches an input signal to be input to the input terminal 133 from input pattern 1 to input pattern 0, and causes transition of the levels of the signals in aggressor wires agg0 and agg1 from one to zero. Also, the design support apparatus fixes victim wire vic at one, measures changes in a signal occurring in victim wire vic when transition was caused in the levels of the signals in aggressor wires agg0 and agg1 from one to zero, and thereby detects crosstalk noise. Note that the purpose of inputting falling signal F to aggressor wires agg0 and agg1 with the level of a signal in victim wire vic fixed at one so as to detect crosstalk noise is to analyze the possibility that the level of a signal in victim wire vic will be wrongly taken as zero through the influence of crosstalk noise. In the explanations below, rising signal R and falling signal F are also referred to as transition signals.

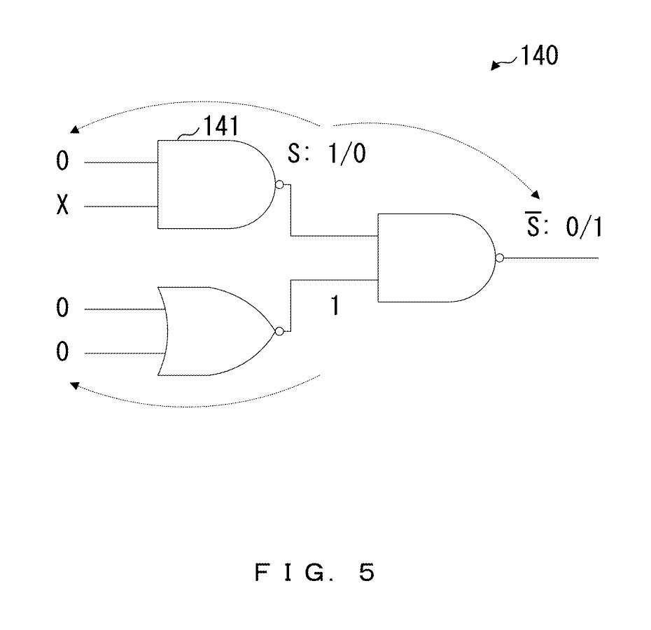

FIG. 5 illustrates input pattern generation.

In order for the design support apparatus to obtain an input pattern for crosstalk analysis, it may be possible to use for example a method similar to back tracing, which is used when obtaining an input pattern for detecting a stuck-at fault by using an ATPG as illustrated in FIG. 5. Back tracing, used for searching for an input pattern for detecting a stuck-at fault, is a method that employs an input signal for converting the output of the output terminal of an element 141 into zero or one by tracing back from the output terminal of the element 141, in which a stuck-at fault occurred. ATPG is an abbreviation for automatic test pattern generator.

In other words, in order to obtain an input pattern for crosstalk analysis, it is possible to search for a combination of input signals to be input to an analysis circuit for converting an output from each output terminal to a set value by tracking back from the output terminal of an element that is connected to the victim wire and the aggressor wire.

As described above, the design support apparatus generates an input vector by using an obtained input pattern so as to cause transition of the signal states of aggressor wires agg0 and agg1 in the analysis circuit 130, and thereby can analyze crosstalk noise occurring in victim wire vic.

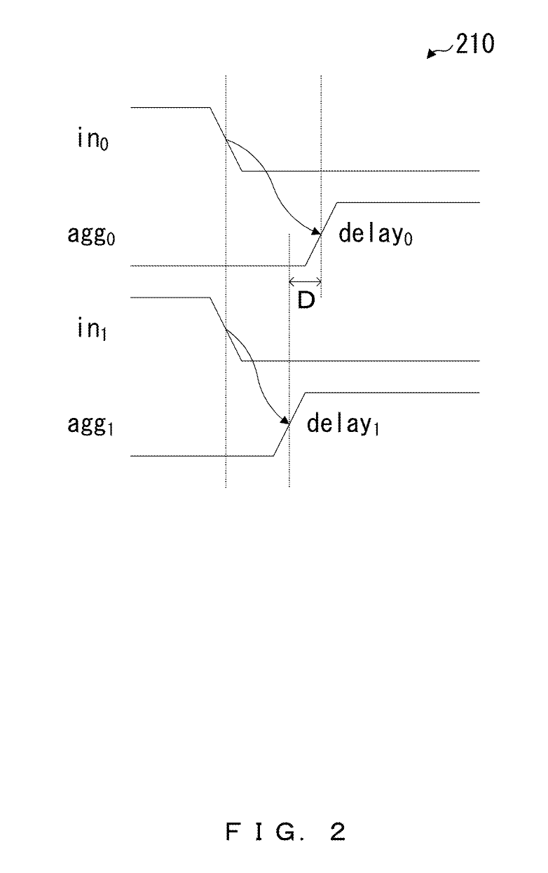

However, in the above method, when the analysis circuit employs a cluster structure, paths connecting the input terminal of the analysis circuit and respective aggressor wires have different delay times, sometimes leading to a situation as illustrated in FIG. 2 where the levels of signals in a plurality of aggressor wires do not transition simultaneously. Because of this, the design support apparatus sometimes fails to detect the worst value of crosstalk noise. Also, in some cases, users perform analysis by using crosstalk noise that is not of the worst value, undervaluing the influence of the crosstalk noise and failing to suppress the possibility of the occurrence of a failure in an integrated circuit.

A design support apparatus according to the embodiment explained below includes a configuration causing simultaneous transition of the levels of signals in a plurality of aggressor wires in order to detect the worst value of crosstalk noise in an analysis circuit employing a cluster structure.

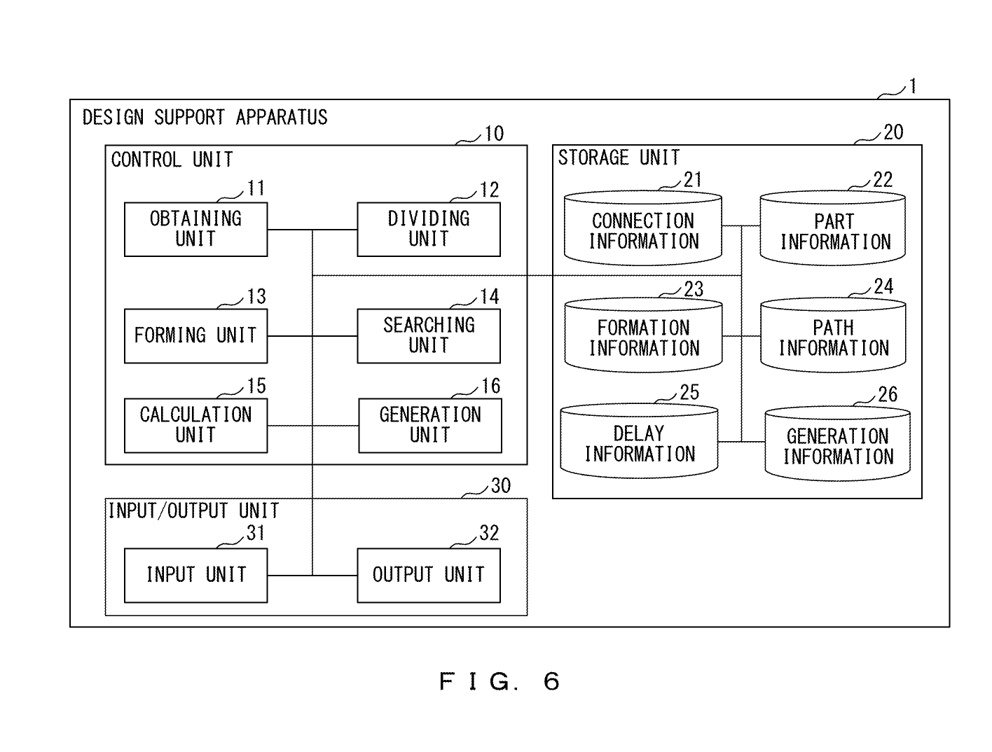

FIG. 6 is a functional block diagram illustrating an example of a design support apparatus.

A design support apparatus 1 will be explained by referring to FIG. 6.

The design support apparatus 1 includes for example a control unit 10, a storage unit 20 and an input/output unit 30. The design support apparatus 1 is for example a computer apparatus, which will be described later.

The control unit 10 includes an obtaining unit 11, a dividing unit 12, a forming unit 13, a searching unit 14, a calculation unit 15 and a generation unit 16. The storage unit 20 includes connection information 21, part information 22, formation information 23, path information 24, delay information 25 and generation information 26. The input/output unit 30 includes an input unit 31 and an output unit 32.

The obtaining unit 11 obtains a net list of an integrated circuit input from the input unit 31, and stores the obtained net list in the connection information 21. In this process, the obtaining unit 11 may perform technology mapping on the obtained net list. Technology mapping is a process in which for example a net list is referred to so that a cell of a cell library is assigned to an element arranged on an integrated circuit. Also, in technology mapping, area, performance, power consumption, etc. may be taken into consideration as conditions when cells are assigned to elements. In the explanations below, the process executed by the control unit 10 is assumed to be performed by using data that has received technology mapping. Also, technology mapping is also referred to as mapping.

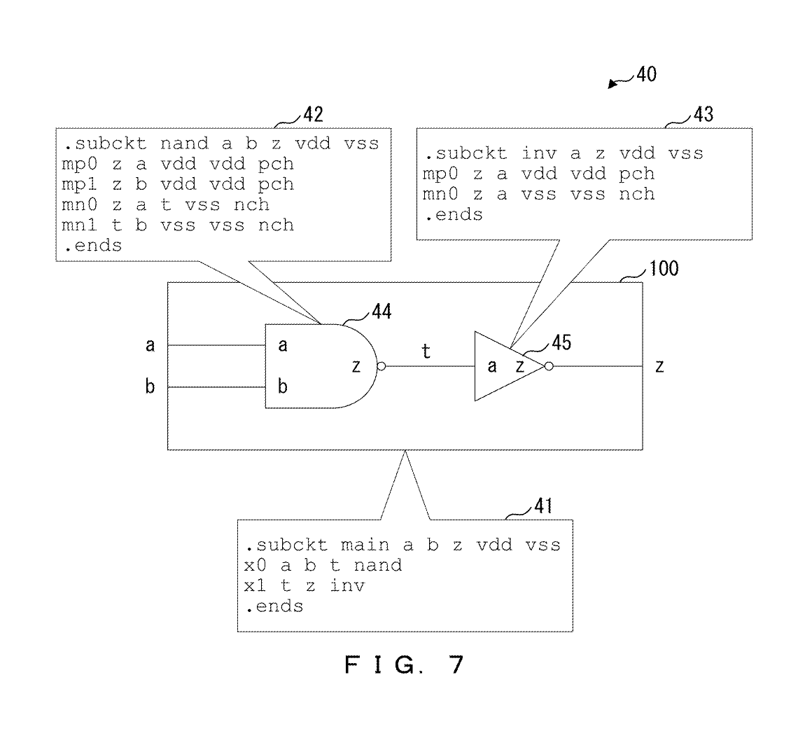

A net list is for example a list that represents connection relationships of elements arranged on an integrated circuit 100, an example of which is a net list 40 illustrated in FIG. 7. A net list 41 illustrates connection relationships between a NAND 44 and a NOT 45 in the integrated circuit 100. Also, a net list 42 illustrates connection relationships of transistors included in the NAND 44. Further, a net list 43 illustrates connection relationships of transistors included in the NOT 45.

The dividing unit 12 divides an integrated circuit into partial circuits. Examples of a partial circuit are partial circuits 51 through 54 that are obtained by separating an integrated circuit 50 for each connection between the source and the drain at power supplies and gates. An example of these is a CCC. CCC is an abbreviation for Channel Connected Component.

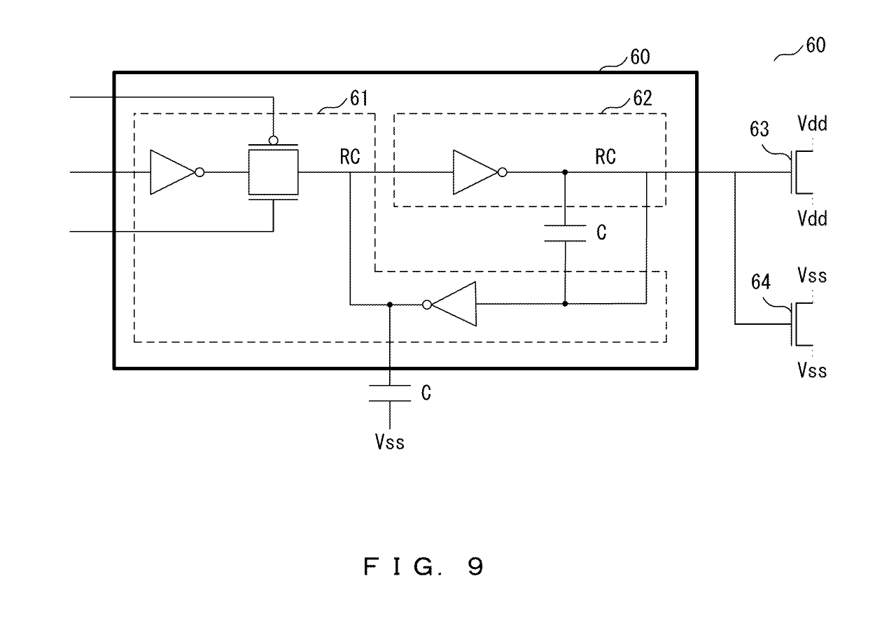

The forming unit 13 forms an analysis circuit by combining a plurality of partial circuits including aggressor wires having influence on a victim wire and a partial circuit including the victim wire. The forming unit 13 for example forms an analysis circuit 60 from a partial circuit 61 and a partial circuit 62 as illustrated in FIG. 9. Also, the number of partial circuits is not limited to two, and the forming unit 13 may form an analysis circuit by combining three or more partial circuits. Also, when partial circuits including aggressor wires that have influence on a victim wire do not exist, the forming unit 13 may form only a partial circuit including the victim wire to form the analysis circuit so as to detect crosstalk noise caused by the influence of an element or a wire in the partial circuit including the victim wire.

Then, the forming unit 13 for example clips the source and drain of a transistor 63, which is a load on the analysis circuit 60, onto Vdd as illustrated in FIG. 9. Further, the forming unit 13 clips for example the source and drain of a transistor 64, which is a load on the analysis circuit 60, onto Vss as illustrated in FIG. 9. Thereby, the design support apparatus 1 analyzes crosstalk noise while ignoring the influence of factors outside the analysis circuit. Accordingly, the design support apparatus 1 can determine the influence of an aggressor wire on a victim wire in the analysis circuit.

Also, the forming unit 13 may form an analysis circuit by combining a partial circuit including an aggressor wire whose capacity coupling with the victim wire has a magnitude equal to or higher than a first threshold, with a partial circuit including the victim wire. Thereby, the design support apparatus 1 can omit calculations of aggressor wires having less influence on victim wires, and thereby can suppress the processing load in crosstalk noise analysis.

As a first threshold, for example a capacity value of the capacity coupling between a victim wire and aggressor wires may be set. For this setting, the forming unit 13 may extract a capacity value equal to or greater than a first threshold from among a plurality of capacity values corresponding to capacity coupling between a victim wire and aggressor wires so as to select at least one partial circuit including an aggressor wire having the extracted capacity value. Also, the forming unit 13 may also form an analysis circuit from the selected at least one partial circuit and a partial circuit including a victim wire. Also, the forming unit 13 may also obtain the capacity value of each capacity coupling by using the length of a victim wire, the lengths of aggressor wires and inter-wire distance between the victim wire and the aggressor wires in the integrated circuit.

Also, as a first threshold, for example the order of capacity values of capacity coupling may be set among a plurality of partial circuits including aggressor wires. For this setting, the forming unit 13 sorts a plurality of capacity values corresponding to capacity coupling between a victim wire and aggressor wires in the order of magnitude and selects at least one partial circuit including an aggressor wire having the extracted capacity value. Then, the forming unit 13 may form an analysis circuit from the selected at least one partial circuit and a partial circuit including a victim wire.

Further, as a first threshold, for example a ratio of capacity coupling between a victim wire and respective aggressor wires to the entirety may be set. For this setting, the forming unit 13 for example sorts a plurality of capacity values corresponding to capacity coupling between a victim wire and aggressor wires in the order of magnitude. Also, the forming unit 13 selects at least one capacity value that has been added until immediately before a total value obtained by adding the sorted capacity values in the order of magnitude becomes equal to or greater than a first threshold. Then, the forming unit 13 may form an analysis circuit from at least one partial circuit including an aggressor wire corresponding to the selected capacity value and a partial circuit including a victim wire.

The forming unit 13 may combine a partial circuit including a transistor whose drivability level is equal to or higher than a second threshold, with a partial circuit including a victim wire. In other words, because the greater the drivability of a transistor is, the greater the influence of an aggressor wire on a victim wire becomes, a second threshold is set in order to ignore the influence of an aggressor wire connected to a transistor with low drivability. Thereby, the design support apparatus 1 can omit calculations of aggressor wires having less influence on victim wires and thereby can suppress the processing load in crosstalk noise analysis.

As a second threshold, for example a switching time of a MOS transistor included in a partial circuit having an aggressor wire may be set as information representing the level of drivability. For this setting, the forming unit 13 may refer to the performance of the transistor that was set in the technology mapping.

The searching unit 14 searches for an input pattern to be input to the analysis circuit by using back tracing. In this process, the searching unit 14 searches for an input pattern that causes transition of the levels of signals in aggressor wires by switching the level of one input signal among input signals for determining the levels of the signals in the aggressor wires that influence a victim wire, which is a crosstalk noise analysis target. Also, the searching unit 14 searches for an input pattern in such a manner that input signals other than input signals to be switched are fixed among input signals that are input to the analysis circuit. Input signals to be switched are for example rising signal R and falling signal F.

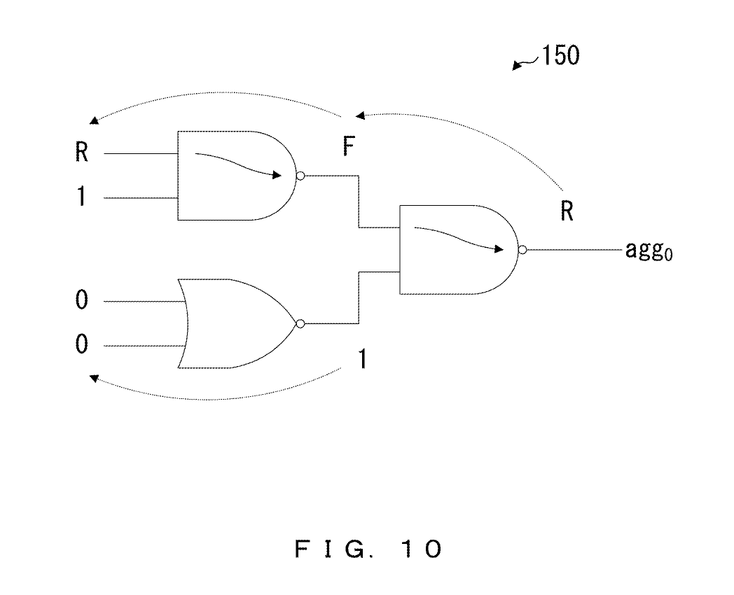

Thereby, the design support apparatus 1 can determine for example the path used for the propagation of rising signal R after being input to the input terminal of the analysis circuit and before reaching aggressor wire agg0 as illustrated in FIG. 10. Also, in a case where falling signal F has been input to the analysis circuit, the design support apparatus 1 can determine the path used for the propagation of falling signal F after being input to the input terminal of the analysis circuit and before reaching aggressor wire agg0 as illustrated in FIG. 10, for example.

Also, the design support apparatus 1 adds delay times of wires and elements in a transition path connecting the input terminal of the analysis circuit receiving an input signal to be switched and the output terminal connected to an aggressor wire, and thereby can calculate the delay time of the transition path.

Accordingly, the design support apparatus 1 shifts the timings of switching the input patterns before and after transition by using the calculated delay time of each transition path, and thereby can cause simultaneous transition of the levels of signals in a plurality of aggressor wires.

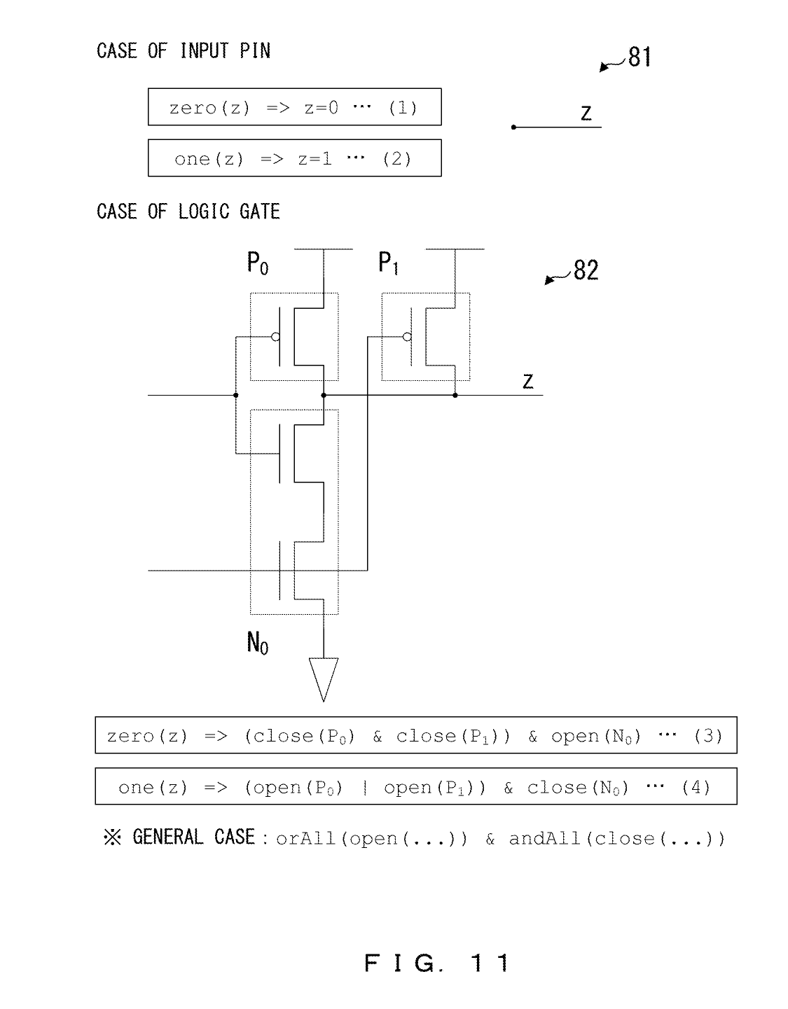

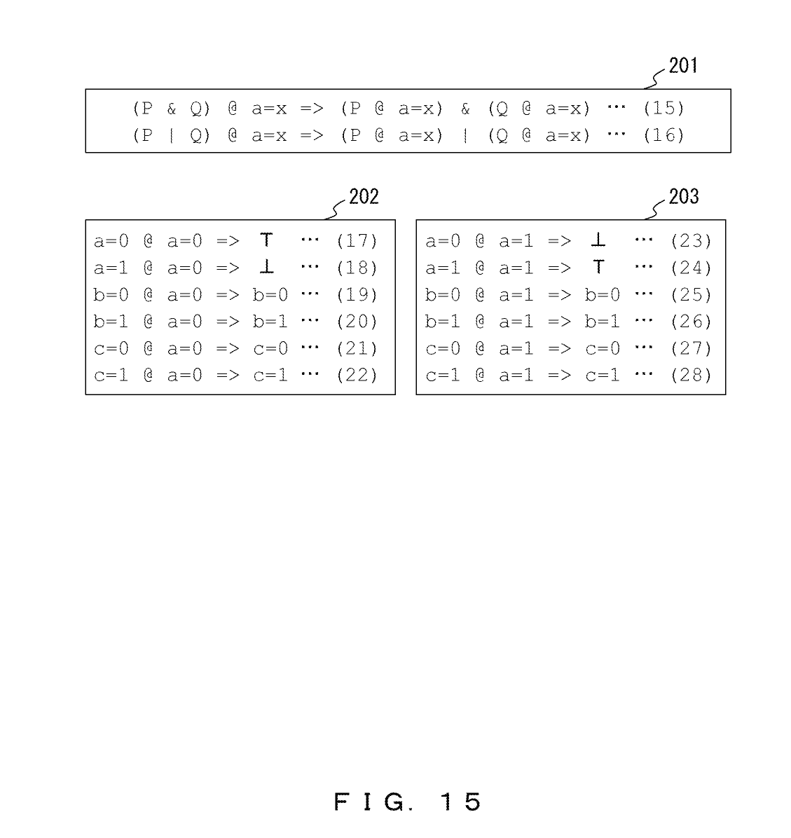

By referring to the conversion rules illustrated in FIG. 11 through FIG. 14 and to the generation conditions illustrated in FIG. 15, explanations will be given for a method in which the searching unit 14 uses back tracing in order to obtain an input pattern that implements an output pattern set for a victim wire and a plurality of aggressor wires.

The back tracing used in this embodiment is a method in which for example an input corresponding to an output of each logic gate is obtained from the output side and thereby an input pattern to be input to the input terminal of the analysis circuit is obtained that accords with the conditions of signals output to the victim wire and the aggressor wires. The conversion rules illustrated in FIG. 11 through FIG. 14 include AND/OR logical expressions, and accordingly, for example, aback track searching method can be used in the back tracing.

In the above process, the design support apparatus 1 according to the embodiment switches the level of one of the input signals, for determining the levels of signals in aggressor wires, to be input to the analysis circuit and thereby searches for an input pattern for causing transition of the levels of signals in the aggressor wires. The conversion rules illustrated in FIG. 11 through FIG. 14 and the generation conditions illustrated in FIG. 15 are used as conditions for searching for an input pattern that causes transition of the levels of signals in the aggressor wires by switching the level of one input signal.

The conversion rules and generation rules may be stored for example in path information 24 by a user beforehand. Also, the conversion rules may be generated for example by the searching unit 14 for corresponding elements that are included in the analysis circuit. Further, the generation conditions may be generated for example by the searching unit 14 for corresponding elements that are included in the analysis circuit.

The searching unit 14 generates a first output pattern, for analyzing crosstalk noise occurring when the levels of signals rise in aggressor wires, in which zero is output to the victim wire and rising signal R is output to a plurality of aggressor wires.

Further, the searching unit 14 generates a second output pattern, for analyzing crosstalk noise occurring when the levels of signals rise in aggressor wires, in which one is output to the victim wire and falling signal F is output to a plurality of aggressor wires.

Then, the searching unit 14 searches for an input pattern that accords with the first and second output patterns by using back tracing.

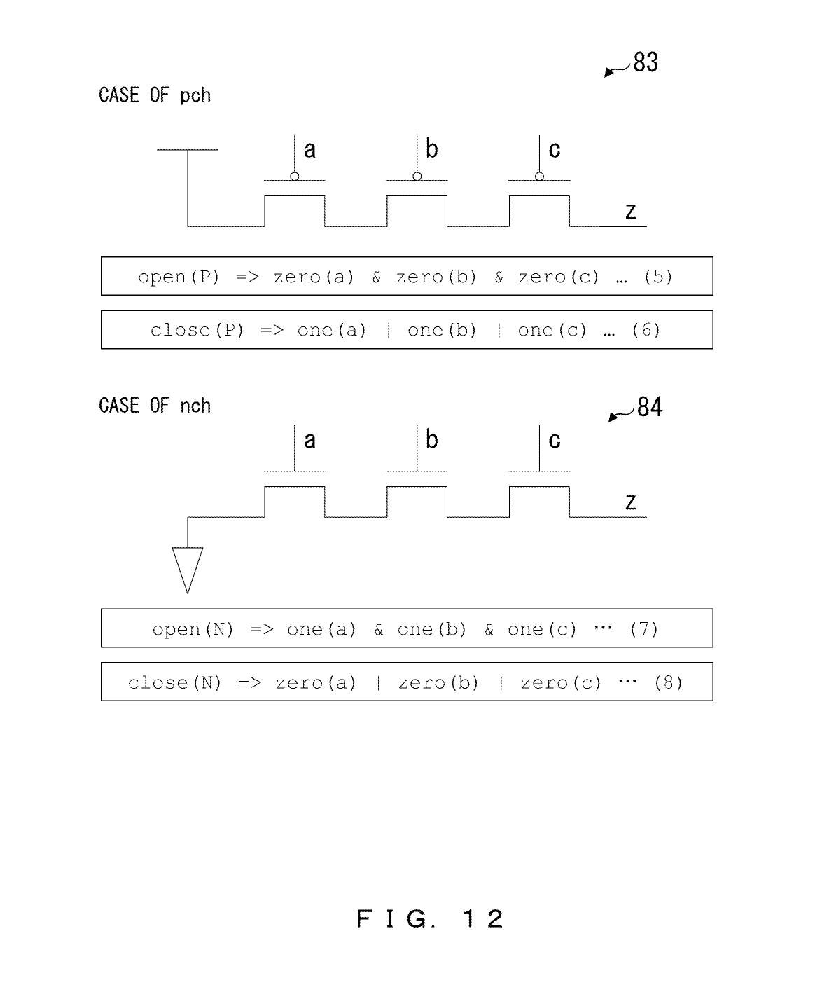

FIG. 11 illustrates 0/1 conversion rules of a node. FIG. 12 illustrates open/close conversion rules of a stack.

By referring to FIG. 11 and FIG. 12, explanations will be given for a method in which the searching unit 14 searches for an input pattern for outputting a fixed signal to a victim wire.

By referring to an input pin 81 illustrated in FIG. 11, explanations will be given for a method in which the searching unit 14 obtains, by using back tracing, an input signal of an input pin that corresponds to the output signal of the input pin.

In expression (1) illustrated in FIG. 11, “zero(z)” denotes that the output signal of the input pin 81 is turned to zero. Also, “z=0” denotes that zero is input to the input pin 81. In other words, expression (1) denotes that when the output signal of the input pin 81 is turned to zero, zero is to be input to the input terminal of the input pin 81.

In expression (2) illustrated in FIG. 11, “one(z)” denotes that the output signal of the input pin 81 is turned to one. Also, “z=1” denotes that one is input to the input pin 81. In other words, expression (2) denotes that when the output signal of the input pin 81 is turned to one, one is to be input to the input terminal of the input pin 81.

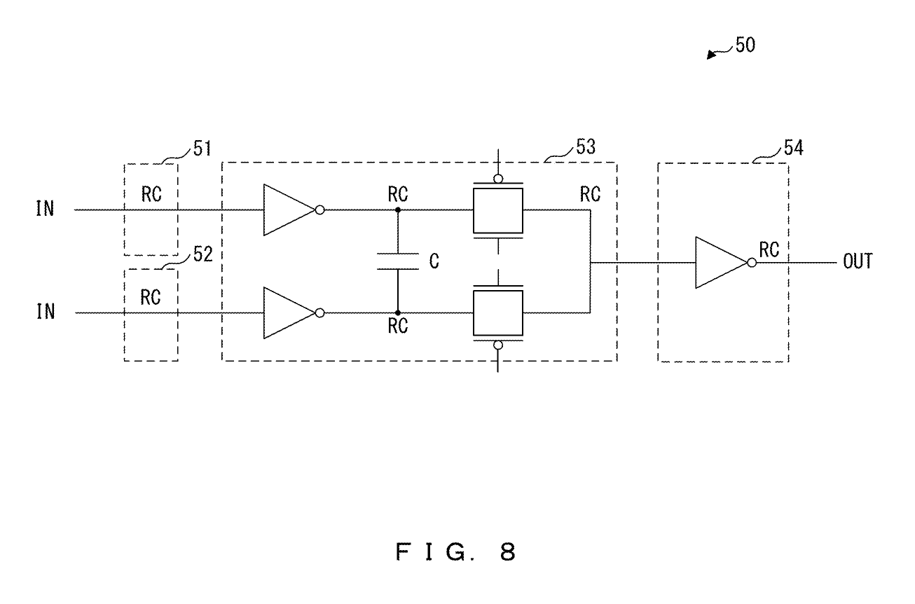

In accordance with the above conversion rules, the searching unit 14 obtains a pattern of an input signal that corresponds to a desired output signal of an input pin. Note that the conditions of expressions (1) and (2) are used for obtaining the input/output relationship of, for example, the partial circuit 51 illustrated in FIG. 8.

By referring to a logic gate 82 illustrated in FIG. 11, explanations will be given for a method in which the searching unit 14 obtains an input signal of the logic gate 82 that corresponds to the output signal of the logic gate 82. Also, in the explanations below, it is assumed that the logic gates are NAND gates. However, the searching unit 14 may also obtain a pattern of an input signal corresponding to the output signal by using relationships of input/output signals for other logic gates.

In expression (3) illustrated in FIG. 11, “zero(z)” denotes that the output signal of a logic gate is turned to zero. Also, “close(P0)” denotes that PMOS switch P0 included in the logic gate 82 is turned to an off state, “close(P1)” denotes that PMOS switch P1 included in the logic gate 82 is turned to an off state, and “open (N0)” denotes that NMOS switch N0 included in the logic gate 82 is turned to an on state. In other words, expression (3) denotes that when the output signal of the logic gate 82 is turned to zero, PMOS switches P0 and P1 are to be turned to an off state and NMOS switch N0 is to be turned to an on state. Note that PMOS is an abbreviation for p-channel (pch) MOS and NMOS is an abbreviation for n-channel (nch) MOS.

In expression (4) illustrated in FIG. 11, “one(z)” denotes that the output signal of a logic gate is turned to one. Also, “open(P0)” denotes that PMOS switch P0 included in the logic gate 82 is turned to an on state, and “open(P1)” denotes that PMOS switch P1 included in the logic gate 82 is turned to anon state. Further, “close (N0)” denotes that NMOS switch N0 included in the logic gate 82 is turned to an off state. In other words, expression (4) denotes that when the output signal of the logic gate 82 is turned to one, PMOS switch P0 or P1 is to be turned to an on state and NMOS switch N0 is to be turned to an off state.

By referring to FIG. 12, explanations will be given for combinations of input signals to be input to the logic gate 82 for turning on/off PMOS switches P0 and P1 and NMOS switch N0 illustrated in FIG. 11. In FIG. 12, explanations will be given on the assumption that PMOS switches P0 and P1 (PMOS switch 83) employ a stack structure in which sources and drains of a plurality of PMOS transistors are connected, and NMOS switch N0 (NMOS switch 84) employs a stack structure in which sources and drains of a plurality of NMOS transistors are connected. Note that an arbitrary number equal to or greater than two of stacks may be used although the number of stacks of the PMOS switches 83 and NMOS switches 84 is three in FIG. 12. Also, the PMOS switch 83 and the NMOS switch 84 may each employ a single transistor instead of a stack structure.

Note that an input signal of the logic gate 82 is an input signal that is input to input terminals a through c of the NMOS switch 84 and input terminals a through c of the PMOS switch 84. The input terminals of the NMOS switch 84 and those of the PMOS switch 83 are given the same reference codes, i.e., a through c, because common input signals are input to them. Also, transistors having input terminals that are given the same reference codes between the NMOS switch 84 and the PMOS switch 83 form a CMOS structure. CMOS is an abbreviation for Complementary MOS.

In expression (5) illustrated in FIG. 12, “open(P)” denotes that the PMOS switch 83 is turned to an on state. Also, “zero(a)” denotes that zero is input to input terminal a (gate terminal) of a PMOS transistor included in the PMOS switch 83, “zero(b)” denotes that zero is input to input terminal b of a PMOS transistor included in the PMOS switch 83, and “zero(c)” denotes that zero is input to input terminal c of a transistor included in the PMOS switch 83. In other words, expression (5) denotes that when the PMOS switch 83 is turned to an on state, zero is to be input to all of input terminals a through c of the PMOS transistors included in the PMOS switch 83.

In expression (6) illustrated in FIG. 12, “close (P)” denotes that the PMOS switch 83 is turned to an off state. Also, “one(a)” denotes that one is input to input terminal a of a transistor included in the PMOS switch 83, “one(b)” denotes that one is input to input terminal b of a PMOS transistor included in the PMOS switch 83, and “one(c)” denotes that one is input to input terminal c of a PMOS transistor included in the PMOS switch 83. In other words, expression (6) denotes that when the PMOS switch 83 is turned to an off state, one is to be input to at least one of input terminals a through c of the PMOS transistors included in the PMOS switch 83.

In expression (7) illustrated in FIG. 12, “open(N)” denotes that the NMOS switch 84 is turned to an on state. Also, “one(a)” denotes that one is input to input terminal a (gate terminal) of an NMOS transistor included in the NMOS switch 84, “one(b)” denotes that one is input to input terminal b of an NMOS transistor included in the NMOS switch 84, and “one(c)” denotes that one is input to input terminal c of an NMOS transistor included in the NMOS switch 84. In other words, expression (7) denotes that when the NMOS switch 84 is turned to an on state, one is to be input to all of input terminals a through c of the transistors included in the NMOS switch 84.

In expression (8) illustrated in FIG. 12, “close (N)” denotes that the NMOS switch 84 is turned to an off state. Also, “zero(a)” denotes that zero is input to input terminal a of an NMOS transistor included in the NMOS switch 84, “zero(b)” denotes that zero is input to input terminal b of a transistor included in the NMOS switch 84, and “zero(c)” denotes that zero is input to input terminal c of an NMOS transistor included in the NMOS switch 84. In other words, expression (8) denotes that when the NMOS switch 84 is turned to an off state, zero is to be input to at least one of input terminals a through c of the NMOS transistors included in the NMOS switch 84.

The searching unit 14 obtains a pattern of an input signal corresponding to a desired output signal of the logic gate 82 by using back tracing in accordance with the above conversion rules. Note that the conditions of expressions (3) through (8) are used for obtaining the input/output relationship of, for example, the NAND gate illustrated in FIG. 10.

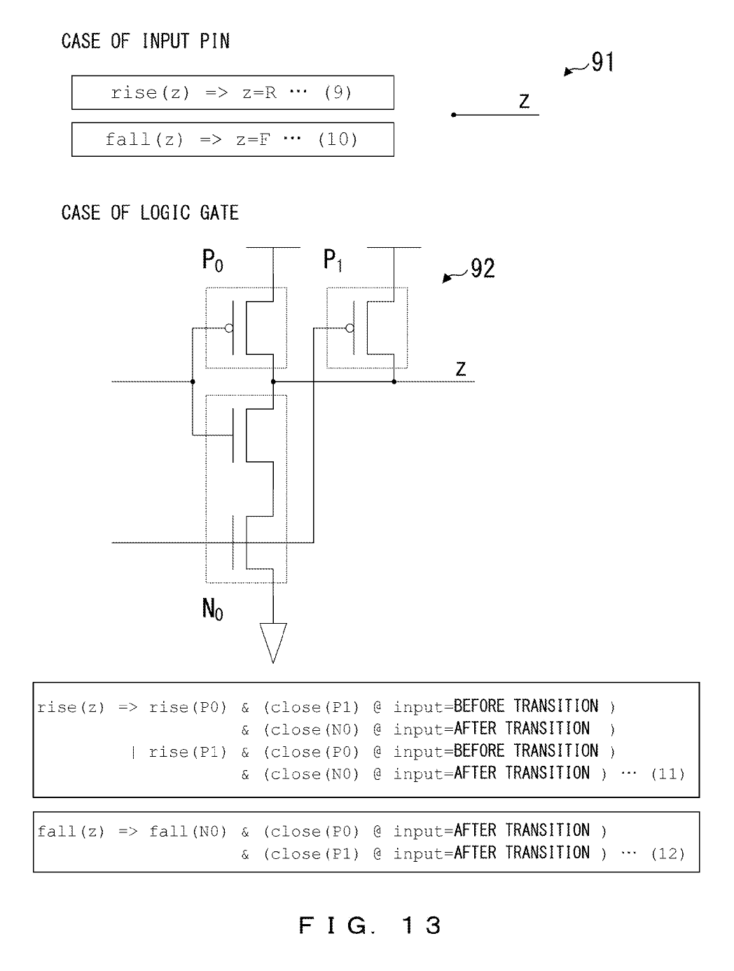

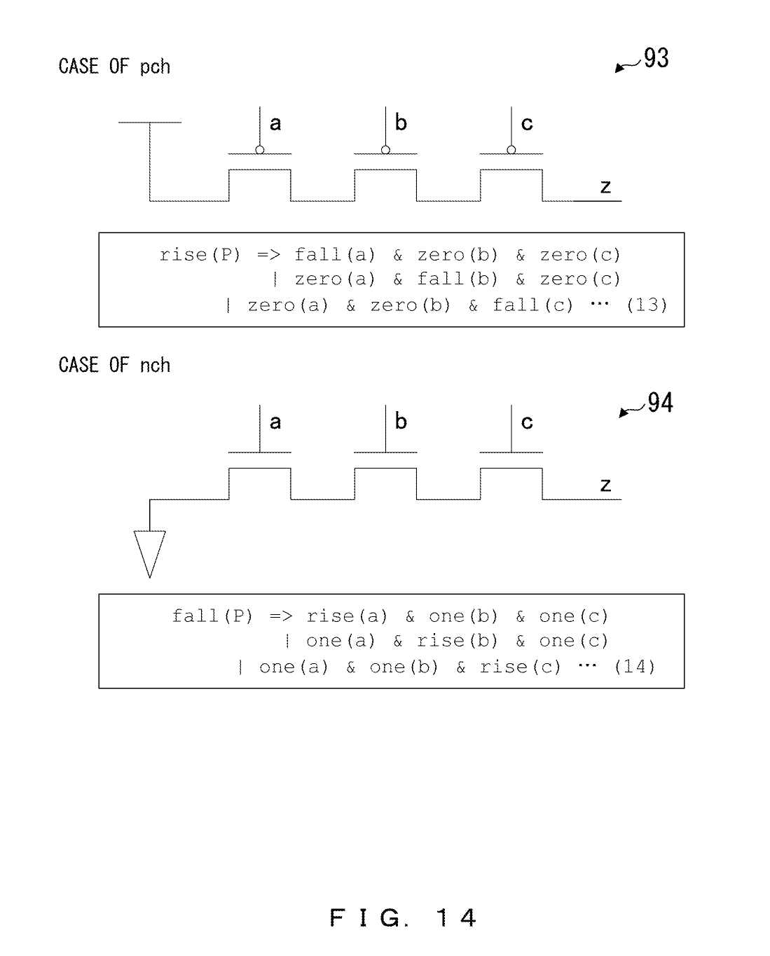

FIG. 13 illustrates rise/fall conversion rules of a node. FIG. 14 illustrates rise/fall conversion rules of a stack.

By referring to FIG. 13 and FIG. 14, explanations will be given for a method in which the searching unit 14 searches for an input pattern for outputting a transition signal to a victim wire.

By referring to an input pin 91 illustrated in FIG. 13, explanations will be given for a method in which the searching unit 14 obtains, by using back tracing, an input signal of an input pin that corresponds to the output signal of the input pin. In the explanations below, rising signal R may also be referred to as “R”. Also, falling signal F may also be referred to as “F”.

In expression (9) illustrated in FIG. 13, “rise(z)” denotes that the output signal of the input pin 91 is turned to R. Also, “z=R” denotes that R is input to the input pin 91. In other words, expression (9) denotes that when the output signal of the input pin 91 is turned to R, R is to be input to the input terminal of the input pin 91.

In expression (10) illustrated in FIG. 13, “fall(z)” denotes that the output signal of the input pin 91 is turned to F. Also, “z=F” denotes that F is input to the input pin 91. In other words, expression (10) denotes that when the output signal of the input pin 91 is turned to F, F is to be input to the input terminal of the input pin 91.

The searching unit 14 obtains a pattern of an input signal corresponding to a desired output signal of the input pin by using the back tracing in accordance with the above conversion rules. Note that the conditions of expressions (9) and (10) are used for obtaining the input/output relationship of, for example, the partial circuit 51 illustrated in FIG. 8.

By referring to a logic gate 92 illustrated in FIG. 13, explanations will be given for a method in which the searching unit 14 obtains an input signal of the logic gate 92 that corresponds to the output signal of the logic gate 92. Also, in the explanations below, it is assumed that logic gates are NAND gates. However, the searching unit 14 may also obtain a pattern of an input signal corresponding to the output signal by using relationships of input/output signals for other logic gates.

In expression (11) illustrated in FIG. 13, “rise(z)” denotes that the output signal of a logic gate is turned to R.

Also, “rise(P0)” denotes that the output signal of PMOS switch P0 included in the logic gate 92 is turned to zero before the transition of R and is turned to one after the transition of R. In other words, “rise(P0)” denotes that PMOS switch P0 included in the logic gate 92 is turned to an off state before the transition of R and is turned to an on state after the transition of R.

Also, “rise(P1)” denotes that the output signal of PMOS switch P1 included in the logic gate 92 is turned to zero before the transition of R and is turned to one after the transition of R. In other words, “rise(P1)” denotes that PMOS switch P1 included in the logic gate 92 is turned to an off state before the transition of R and is turned to an on state after the transition of R.

Also, “close(P0)” denotes that PMOS switch P0 included in the logic gate 92 is turned to an off state, and “close(P1)” denotes that PMOS switch P1 included in the logic gate 92 is turned to an off state. Further, “close(N0)” denotes that NMOS switch N0 included the logic gate 92 is turned to an off state.

In other words, expression (11) denotes that when the output signal of the logic gate 92 is turned to R, PMOS switches P0 and P1 are to be turned to an off state before the transition of R. Expression (11) also denotes that when the output signal of the logic gate 92 is turned to R, PMOS switch P0 is to be turned to an on state and NMOS switch N0 is to be turned to an off state after the transition of R.

In expression (12) illustrated in FIG. 13, “fall(z)” denotes that the output signal of a logic gate is turned to F.

Also, “fall (N0)” denotes that the output signal of NMOS switch N0 included in the 92 is turned to one before the transition of F and is turned to zero after the transition of F. In other words, “fall (N0)” denotes that NMOS switch N0 included in the logic gate 92 is turned to an off state before the transition of N and is turned to an on state after the transition of F.

Also, “close(P0)” denotes that PMOS switch P0 included in the logic gate 92 is turned to an off state, and “close(P1)” denotes that PMOS switch P1 included in the logic gate 92 is turned to an off state.

Accordingly, expression (12) denotes that NMOS switch N0 is to be turned to an on state and PMOS switches P0 and P1 are to be turned to an off state after the transition of F.

By referring to FIG. 14, explanations will be given for combinations of input signals to be input to the logic gate 92 in order to turn output signals of PMOS switches P0 and P1 and NMOS switch N0 illustrated in FIG. 13 to R and F. In FIG. 14, explanations will be given on the assumption that PMOS switches P0 and P1 (PMOS switch 93) employ a stack structure in which sources and drains of a plurality of PMOS transistors are connected. It is also assumed that NMOS switch N0 (NMOS switch 94) employs a stack structure in which sources and drains of a plurality of NMOS transistors are connected. Also, note that an arbitrary number equal to or greater than two of stacks may be used although the number of stacks of PMOS switches 93 and NMOS switches 94 is three in FIG. 14. Also, the PMOS switch 93 and the NMOS switch 94 may each employ a single transistor instead of a stack structure.

An input signal of the logic gate 92 is an input signal that is input to input terminals a through c of the NMOS switch 93 and input terminals a through c of the PMOS switch 94. The input terminals of the NMOS switch 93 and those of the PMOS switch 94 are given the same reference codes, i.e., a through c, because common input signals are input to them. Also, transistors having input terminals that are given the same reference codes between the NMOS switch 93 and the PMOS switch 94 form a CMOS structure.

In expression (13) illustrated in FIG. 14, “rise (P)” denotes that output signal z of the PMOS switch 93 is turned to R. Also, “fall(a)” through “fall(c)” respectively denote that F is input to input terminals a through c of the PMOS transistors included in the PMOS switch 93, and “zero(a)” through “zero(c)” respectively denote that zero is input to input terminals a through c of the PMOS transistors included in the PMOS switch 93. In other words, expression (13) denotes that when the output signal of the PMOS switch 93 is turned to R, one is to be input to one of input terminals a through c of the PMOS switch 93 and zero is to be input to the other input terminals before the transition of R. Also, expression (13) denotes that when the output signal of the PMOS switch 93 is turned to R, zero is to be input to all of input terminals a through c of the PMOS switch 93 after the transition of R.

In expression (14) illustrated in FIG. 14, “fall(P)” denotes that output signal z of the NMOS switch 94 is turned to F. Also, “rise(a)” through “rise(c)” respectively denote that R is input to input terminals a through c of the NMOS transistors included in the NMOS switch 94, and “one(a)” through “one(c)” respectively denote that one is input to input terminals a through c of the NMOS transistors included in the NMOS switch 94. In other words, expression (14) denotes that when the output signal of the NMOS switch 94 is turned to F, zero is to be input to one of input terminals a through c of the PMOS switch 93 and one is to be input to the other input terminals before the transition of F. Also, expression (14) denotes that when the output signal of the PMOS switch 93 is turned to F, one is to be input to all of input terminals a through c of the PMOS switch 93 after the transition of F.

In accordance with the above conversion rules, the searching unit 14 obtains a pattern of an input signal that corresponds to a desired output signal of the logic gate 92 by using back tracing. Note that the conditions of expressions (1) through (14) are used for obtaining the input/output relationship of, for example, the NAND gate illustrated in FIG. 10.

Explanations will be given for a process in which the searching unit 14 obtains a transition path.

The searching unit 14 switches the level of an input signal of a logic gate having its output terminal connected to an aggressor wire, and thereby sets a combination of input signals that are input to a logic gate included in the analysis circuit in such a manner that the level of an output signal transitions.

The searching unit 14 further switches the level of an input signal for a logic gate connected to the terminal of the logic gate to which the input signal to be switched is input, and thereby sets a combination of input signals so that the level of an output signal transitions.

The searching unit 14 further sets a combination of input signals for a logic gate connected to the terminals of the logic gate other than the terminal to which the input signal to be switched is input so that the level of an output signal is fixed.

In this process, the searching unit 14 uses the conversion rules explained by using FIG. 11 through FIG. 14 so as to set a combination of input signals to be input to the logic gate according to the embodiment in accordance with the conditions illustrated in FIG. 15.

By referring to FIG. 13 through FIG. 15, explanations will be given for a process in which the searching unit 14 obtains a combination of input signals to be input to the logic gate 92. Conditions 201 through 203 illustrated in FIG. 15 are conditions of a combination of input signals that may be set in back tracing that has taken a transition signal into consideration. In the explanations below, it is assumed as an example that the output signal of the logic gate 92 is rising signal R. It is also assumed that input terminals a through c are input terminals a through c of the logic gate 92 and the NMOS switch 94 illustrated in FIG. 14. However, the searching unit 14 may also obtain a pattern of an input signal corresponding to the output signal by setting corresponding conditions for a combination of a different transition signal and a different logic gate.

Explanations will be given for the condition 201.

In expression (15) illustrated in FIG. 15, “P” denotes for example “rise(P0)”in expression (11) illustrated in FIG. 13. Also, in expression (15) illustrated in FIG. 15, “Q” denotes for example “close (P1)”before the transition or “close (N0)” after the transition.

Also, “a=x” represents for example a condition that falling signal F that is inverse to rising signal R, which is the output signal of the logic gate 92, be input to input terminal a illustrated in FIG. 14. Also, “a=x” may further represent a condition that signals input to the input terminals other than input terminal a be fixed. In other words, a condition may be used that the same signal be input to input terminals b and c between before and after the transition of the output signal of the logic gate 92.

Accordingly, expression (15) denotes for example that one is input to input terminal a of PMOS switch P0∩PMOS switch P1 of the logic gate 92 before the transition of the input signal of the logic gate 92. Further, expression (15) denotes that inputting one to input terminal a of PMOS switch P0∩PMOS switch P1 is equivalent to inputting one to input terminal a of PMOS switch P0 and PMOS switch P1. By conforming to the condition 201, the searching unit 14 searches for a combination of input signals that inputs one to input terminal a of PMOS switch P0 and PMOS switch P1 from among combinations of input signals of the logic gate 92 that turns the output signal of the logic gate 92 to zero. Note that input terminal a is used in common by PMOS switch P0 and PMOS switch P1.

Also, expression (15) denotes for example that zero is input to input terminal a of PMOS switch P0∩NMOS switch N0 of the logic gate 92 after the transition of the output signal of the logic gate 92. Further, expression (15) denotes that inputting zero to input terminal a of PMOS switch P0∩NMOS switch N0 is equivalent to inputting zero to input terminal a of PMOS switch P0 and NMOS switch N0. By conforming to the condition 201, the searching unit 14 searches for a combination of input signals that inputs zero to input terminal a of PMOS switch P0 and NMOS switch N0 from among combinations of input signals of the logic gate 92 that turns the output signal of the logic gate 92 to one.

Also, “P” in expression (16) illustrated in FIG. 15 denotes for example “rise(P0)∩” (close(P1)@input=before transition) in expression (11) illustrated in FIG. 13. “Q” in expression (16) illustrated in FIG. 15 denotes for example “rise (P1)∩” (close(P0)@input=before transition). In other words, expression (16) illustrated in FIG. 15 denotes that when the conversion rules are expressed by “or”, one of the conversion rules is to be obeyed.

Explanations will be given for the conditions 202 and 203.

Expression (17) in the condition 202 denotes that zero maybe set to an input signal to be input to input terminal a when a search is conducted for a combination of input signals that inputs zero to input terminal a. Expression (18) in the condition 202 denotes that it is prohibited to set one for an input signal to be input to input terminal a when a search is conducted for a combination of input signals that inputs zero to input terminal a.

Expression (19) in the condition 202 denotes that zero may be set for an input signal to be input to input terminal b when a search is conducted for a combination of input signals that inputs zero to input terminal a. Expression (20) in the condition 202 denotes that one may be set for an input signal to be input to input terminal b when a search is conducted for a combination of input signals that inputs zero to input terminal a.

Expression (21) in the condition 202 denotes that zero may be set for an input signal to be input to input terminal c when a search is conducted for a combination of input signals that inputs zero to input terminal a. Expression (22) in the condition 202 denotes that one may be set for an input signal to be input to input terminal c when a search is conducted for a combination of input signals that inputs zero to input terminal a.

Expression (23) in the condition 203 denotes that it is prohibited to set zero for an input signal to be input to input terminal a when a search is conducted for a combination of input signals that inputs one to input terminal a. Expression (24) in the condition 202 denotes that one may be set for an input signal to be input to input terminal a when a search is conducted for a combination of input signals that input one to input terminal a.

Expression (25) in the condition 202 denotes that zero may be set for an input signal to be input to input terminal b when a search is conducted for a combination of input signals that inputs one to input terminal a. Expression (26) in the condition 202 denotes that one may be set for an input signal to be input to input terminal b when a search is conducted for a combination of input signals that inputs one to input terminal a.

Expression (27) in the condition 202 denotes that zero may be set for an input signal to be input to input terminal c when a search is conducted for a combination of input signals that inputs one to input terminal a. Expression (28) in the condition 202 denotes that one may be set for a input signal to be input to input terminal c when a search is conducted for a combination of input signals that inputs one to input terminal a.

When the output signal of the logic gate 92 is R (zero before transition), for example one, which is the inverse logical value, is input to input terminal a before the transition. Accordingly, the condition 203 serves as a condition of searching for a combination of corresponding input signals before the transition of output signal R of the logic gate 92. When the output signal of the logic gate 92 is R (one after transition), for example zero, which is the inverse logical value, is input to input terminal a after the transition. Accordingly, the condition 202 serves as a condition of searching for a combination of corresponding input signals after the transition of output signal R of the logic gate 92.

When the output signal of the logic gate 92 is F (one before transition), for example zero, which is the inverse logical value, is input to input terminal a before the transition. Accordingly, the condition 202 serves as a condition of searching for a combination of corresponding input signals before the transition of output signal F of the logic gate 92. When the output signal of the logic gate 92 is F (zero after transition), for example one, which is the inverse logical value, is input to input terminal a after the transition. Accordingly, the condition 203 serves as a condition of searching for a combination of corresponding input signals after the transition of output signal F of the logic gate 92.

By conforming to the conditions 201 through 203 above, the searching unit 14 obtains a pattern of an input signal corresponding to a desired output signal of the logic gate 92 by using back tracing.

When for example the analysis circuit 130 has two aggressor wires agg0 and agg1 as illustrated in FIG. 4, the searching unit 14 sets the same level for signals of aggressor wires agg0 and agg1 between before and after transition. Also, the searching unit 14 may search for an input pattern to be input to the analysis circuit by using back tracing so that both of aggressor wires agg0 and agg1 accord with the same signal level. Thereby, when the searching unit 14 performs analysis of crosstalk noise, the searching unit 14 can obtain an input pattern for causing transition of the levels of signals to the same level of aggressor wires agg0 and agg1.

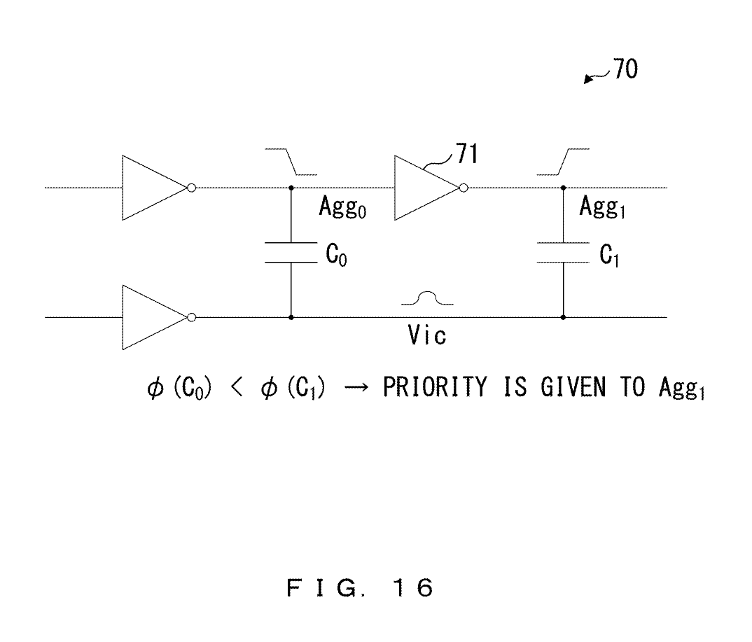

When for example there is not a combination of input signals that makes aggressor wires agg 0 and agg 1 accord with the same level of signals as illustrated in FIG. 16, the searching unit 14 gives priority to the level of a signal of the aggressor wire having the greater influence on victim wire vic. Also, when φ(C0)<φ(C1) is satisfied as illustrated in FIG. 16, the searching unit 14 may search for a combination of input signals of the analysis circuit by using back tracing so that the level of a signal of aggressor wire agg1, which has been given priority, is satisfied.

Here, “φ(C0)” and “φ(C1)” are evaluation functions φ that express the degrees to which aggressor wires agg0 and agg1 have influence on victim wire vic. Evaluation function φ may be set in such a manner that for example it becomes greater in proportion to the level of the capacity coupling between an aggressor wire and a victim wire. Also, an evaluation function may be set in such a manner that for example it becomes greater in proportion to the level of the drivability of an element that outputs a signal to an aggressor wire. Also, the level of the capacity coupling between an aggressor wire and a victim wire may be obtained from the length of aggressor wires, the length of a victim wire and the distance between the aggressor wires and the victim wire.

Because for example aggressor wire agg0 and agg1 are connected in series via NOT 71 in FIG. 16, it is not possible to accord with the same level of signals simultaneously. Also, when aggressor wires agg0 and agg1 are in parallel as illustrated in FIG. 4, it is not possible to accord with the same level of signals in some cases when the paths of aggressor wires agg0 and agg1 partially pass through the same path in the combinational circuit 131. Also, in this case, the searching unit 14 may give priority to the level of a signal of the aggressor wire having the greater influence on victim wire vic for searching for a combination of input signals on the analysis circuit by using back tracing.

Explanations will be given by referring to FIG. 6.

The calculation unit 15 calculates a delay time of a transition path connecting the input terminal of the analysis circuit to which input signal to be switched is input and the output terminal connected to an aggressor wire. For this calculation, the calculation unit 15 may add the delay time caused by the respective logics included in the transition path and the delay times caused by the respective wires by referring to cells assigned in mapping so as to calculate the delay time of the transition path.

The generation unit 16 generates an input vector that shifts, by the difference between the delay times of the respective transition paths, the switching of the levels of input signals to be input to the first transition path and the second transition path included in the analysis circuit in such a manner that the levels of signals of aggressor wires agg 0 and agg1 will transition simultaneously. Aggressor wires agg0 and agg1 are for example aggressor wires included in the analysis circuit. A first transition path is for example a transition path connected to aggressor wire agg0. A second transition path is for example a transition path connected to aggressor wire agg1. An input vector is information representing an input pattern of a signal to be input to the circuit by the design support apparatus 1 and the timing of inputting the input pattern. The design support apparatus 1 inputs the signal of each input pattern at a specified timing in accordance with the information of the input vector.

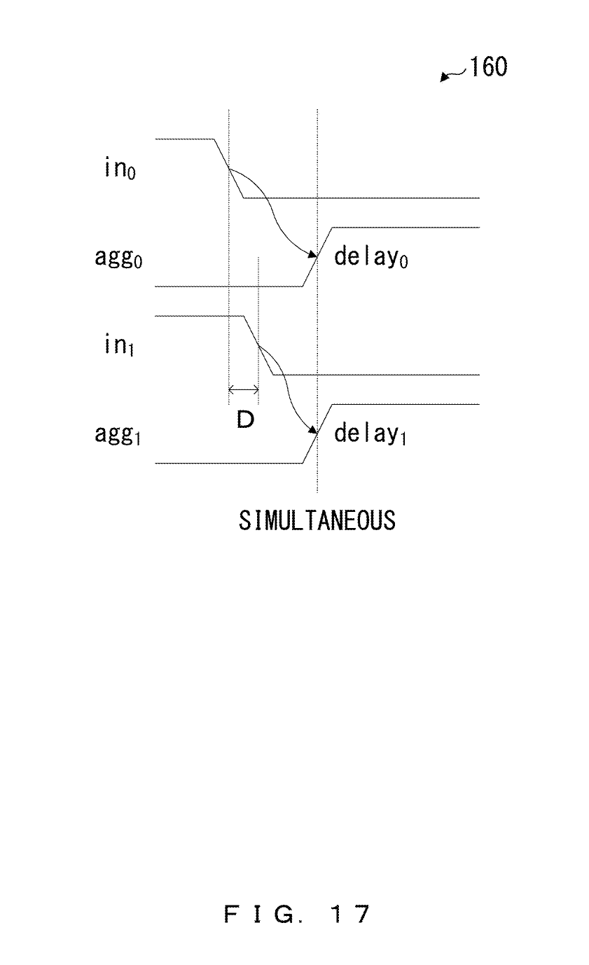

When for example aggressor wires agg0 and agg1 are included in the analysis circuit as illustrated in FIG. 4, the generation unit 16 obtains the difference between delay time delay0 of the first transition path and delay time delay1 of the second transition path as illustrated in FIG. 17. Also, the generation unit 16 may generate an input vector that delays, by difference D, the switching of the level of the signal input to the second transition path from the switching of the level of the signal input to the first transition path.

The generation unit 16 obtains a difference between the longest delay time and other delay times among delay times of transition paths connected to a plurality of aggressor wires included in the analysis circuit 130. Also, the generation unit 16 may generate an input vector that for example delays, by the difference, the switching of the level of the input signal to be input to the paths having other delay times than the switching of the level of the signal input to the path having the longest delay time.

The connection information 21 stores for example a net list of an integrated circuit input from the input unit 31. The connection information 21 also stores for example data of an integrated circuit mapped by using the net list of the integrated circuit.

The part information 22 for example stores connection information of a partial circuit obtained as a result of the division performed by the dividing unit 12. Connection information of a partial circuit maybe for example the net list of a partial circuit and data of a partial circuit mapped by using the net list of the partial circuit.

The formation information 23 stores for example connection information of the analysis circuit formed by the forming unit 13. Connection information of the analysis circuit maybe for example the net list of the analysis circuit and data of the analysis circuit mapped by using the net list of the analysis circuit.

The path information 24 stores for example the conversion rules illustrated in FIG. 11 through FIG. 14, the generation conditions illustrated in FIG. 15 and information of a transition path that was searched for by the searching unit 14. Information of a transition path maybe for example information representing a connection relationship between a wire and a logic gate included in a transition path.

The delay information 25 stores for example a delay time of each transition path calculated by the calculation unit 15.

The generation information 26 stores for example an input pattern obtained by the search performed by the searching unit 14 and an input vector generated by the generation unit 16.

The input unit 31 receives inputs of, for example, a net list of an integrated circuit.

The output unit 32 outputs for example an input vector generated by the generation unit 16.

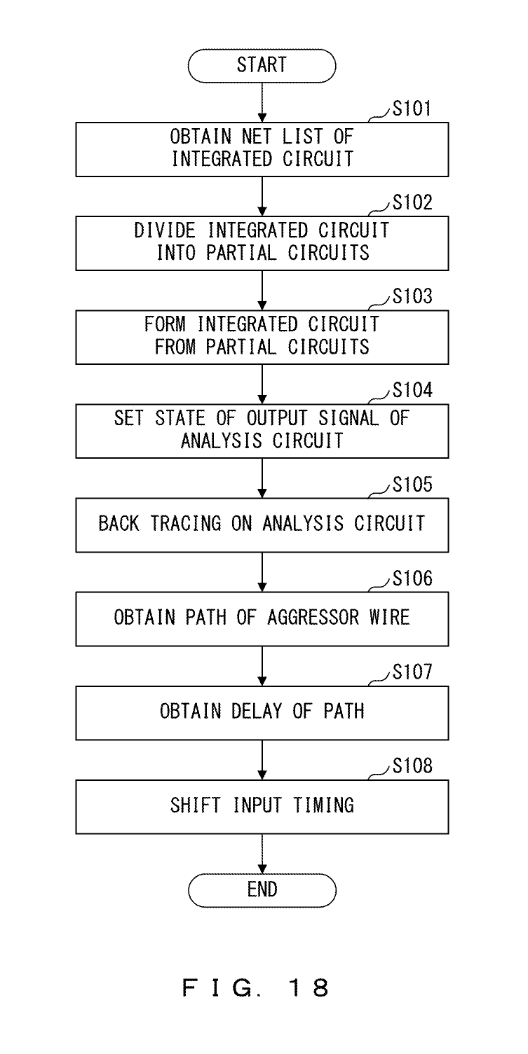

FIG. 18 is a flowchart explaining a generation process of an input vector.

By referring to FIG. 18, explanations will be given for a process of generating an input vector that makes the design support apparatus 1 illustrated in FIG. 6 cause transition of the levels of signals in a plurality of aggressor wires included in the analysis circuit. In the explanations below, it is assumed that the net list 40 has been input to the input unit 31.

The obtaining unit 11 performs technology mapping (S101) on the net list 40 input from the input unit 31.

The dividing unit 12 refers to data of an integrated circuit mapped by the obtaining unit 11, and generates data of a partial circuit obtained by division based on connections between sources and drains by partitioning the integrated circuit 100 for each power source and gate (S102).

The forming unit 13 refers to data of a partial circuit obtained by the division performed by the dividing unit 12 and generates data of the analysis circuit as a result of combining a partial circuit having the victim wire and a plurality of partial circuits having aggressor wires that have influence on the victim wire (S103).

The searching unit 14 refers to data of the analysis circuit formed by the forming unit 13 and sets states of output signals for the victim wire and a plurality of aggressor wires included in the analysis circuit, respectively (S104). When for example the searching unit 14 has set zero for the level of a signal of the victim wire, the searching unit 14 sets rising signal R as signals of a plurality of aggressor wires. Also, when for example the searching unit 14 has set one for the level of the signal of the victim wire, the searching unit 14 sets falling signal F as signals of a plurality of aggressor wires.

The searching unit 14 searches for an input pattern that accords with the set states of output signals by using back tracing (S105). In this search, the searching unit 14 searches for a pair of input patterns for causing transition of the levels of signals in the aggressor wires just by switching an input signal to be input to the analysis circuit. When there are a plurality of pairs of input patterns that accord with the set states of output signals, the searching unit 14 may terminate a search after searching among a prescribed number (at least one) of input patterns. Thereby, the design support apparatus 1 can suppress loads of the processing load in searching for input patterns. Also, when the searching unit 14 has obtained a plurality of input patterns that accord with the set states of output signals, the generation unit 16 may generate an input vector for crosstalk noise analysis by using each input pattern in 5108. Thereby, the design support apparatus 1 can detect the influence of crosstalk noise caused by a signal that has propagated through a plurality of transition paths, improving the accuracy of the crosstalk noise analysis.

The searching unit 14 obtains, as a transition path, a path connecting the input terminal of the analysis circuit for receiving the input of an input signal, which will be switched to cause the transmission of the levels of signals in aggressor wires, and the output terminal connected to an aggressor wire (S106).

The calculation unit 15 calculates the delay time of a transition path, obtained by the searching unit 14, connected to each aggressor wire (S107).

The generation unit 16 uses a plurality of delay times calculated by the calculation unit 15 so as to generate an input vector that is a result of shifting the timings of input signals to be input to the input terminals of a plurality of transition paths in such a manner that the levels of the signals in a plurality of aggressor wires transition simultaneously (S108).

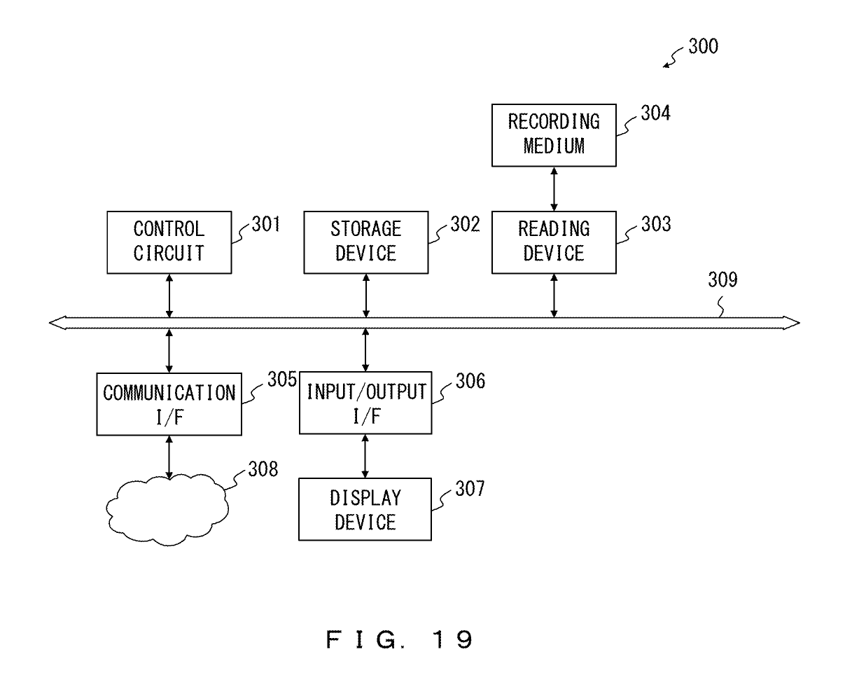

FIG. 19 is a block diagram illustrating an example of a computer apparatus.

By referring to FIG. 19, explanations will be given for a configuration of the design support apparatus 1.

In FIG. 19, a computer apparatus 300 includes a control circuit 301, a storage device 302, a reading device 303, a recording medium 304, a communication interface (communication I/F) 305, an input/output interface (input/output I/F) 306, a display device 307 and a network 308. The respective constituents are connected via a bus 309.

The control circuit 301 performs overall control of the computer apparatus 300. The control circuit 301 is a processor such as, for example, a CPU, a multi-core CPU, an FPGA (Field Programmable Gate Array), a PLD (Programmable Logic Device), etc. The control circuit 301 functions as, for example, the control unit 10 in FIG. 6. The connection information 21, the part information 22, the formation information 23, the path information 24, the delay information 25 and the generation information 26 stored in the storage unit 20 may be stored in, for example, a cache of the CPU, the FPGA, or the PLD.

The storage device 302 stores various types of data items. The storage device 302 includes a memory such as, for example, ROM (Read Only Memory), RAM (Random Access Memory), etc., and a computer-readable recording medium such as, for example, an HD (Hard Disk). The storage device 302 functions as, for example, the storage unit 20 in FIG. 6. The storage device 302 may store for example the connection information 21, the part information 22, the formation information 23, the path information 24, the delay information 25 and the generation information 26 illustrated in FIG. 6.

The ROM stores a program such as a boot program. The ROM is used as a work area of the control circuit 301. The HD stores programs such as an OS, an application program, firmware, and various types of data items.

The storage device 302 stores for example an input vector generation program that makes the control circuit 301 function as the control unit 10.

When performing a data transfer process, the design support apparatus 1 reads into the RAM an input vector generation program stored in the storage device 302. Then, the design support apparatus 1 makes the control circuit 301 execute the input vector generation program read into the RAM, and thereby executes the process of generating an input vector.

Note that when the control circuit 301 can be accessed via the communication interface 305, the input vector generation program may be stored in a storage device included in a server in the network 308.

The reading device 303 reads/writes data of the recording medium 304 that is controlled by the control circuit 301 and that is detachable. The reading device 303 is for example an FDD (Floppy Disk Drive), a CDD (Compact Disc Drive), a DVDD (Digital Versatile Disk Drive), a BDD (Blu-ray (registered trademark) Disk Drive), a USB (Universal Serial Bus), etc.

The recording medium 304 stores various types of data items. The recording medium 304 stores for example the input vector generation program. Further, the recording medium 304 may store the connection information 21, the part information 22, the formation information 23, the path information 24, the delay information 25 and the generation information 26 illustrated in FIG. 6.

The recording medium 304 is connected to the bus 309 via the reading device 303, and the control circuit 301 controls the reading device 303 so as to perform reading/writing of data. The recording medium 304 is a non-transitory computer-readable recording medium such as, for example, an FD (Floppy Disk), a CD (Compact Disc), a DVD (Digital Versatile Disk), a BD (Blu-ray (registered trademark) Disk), flash memory, etc.

The communication interface 305 connects the computer apparatus 300 to other devices via the network 308 so that communication is possible between them.

The input/output interface 306 is connected to, for example, a keyboard, a mouse, a touch panel, etc., and when a signal representing various types of information items has been input from a connected device, the input/output interface 306 outputs, to the control circuit 301, the signal input via the bus 309. Also, when a signal representing various types of information items output from the control circuit 301 has been input via the bus 309, the input/output interface 306 outputs that signal to respective connected devices. The input/output interface 306 functions as, for example, the input/output unit 30 in FIG. 6.

The display device 307 is connected to, for example, the input/output interface 306 and displays various types of information items.

The network 308 is for example a LAN, wireless communication, the Internet, etc., and provides communication connection between the computer apparatus 300 and other devices.

As described above, the design support apparatus 1 according to the embodiment searches for an input pattern that causes transition of the levels of signals of aggressor wires included in the analysis circuit by switching the level of a signal input to the analysis circuit. Also, the design support apparatus 1 calculates the delay time of the transition path that connects the input terminal of the analysis circuit to which the input signal to be switched is to be input and the output terminal connected to the aggressor wires. The design support apparatus 1 shifts the timing of switching of the input patterns before and after transition by using the calculated delay time of each transition path so that the levels of signals in the plurality of aggressor wires transition simultaneously. This makes it possible for the design support apparatus 1 to cause simultaneous transition of the levels of signals in the plurality of aggressor wires.

Also, the design support apparatus 1 simultaneously causes transition of the levels of signals in a plurality of aggressor wires, leading to abrupt changes of the signals in the plurality of aggressor wires in comparison with the victim wire. This makes it possible for the design support apparatus 1 to increase the influence of the plurality of aggressor wires on the victim wire and thereby to detect the worst value of crosstalk noise highly accurately.

Further, the design support apparatus 1 feeds back the worst value of detected crosstalk noise in the design phase, thereby making it possible to increase, in the design phase, the accuracy of suppressing the possibility that failures will occur in an integrated circuit in the production phase.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiment of the present invention have been described in detail, it should be understood that various changes, substitutions, and alterations could be made hereto without departing from the spirit and scope of the invention.

What is claimed is:

1. A design support apparatus comprising a processor that executes a process, the process comprising:
searching, by using back tracing, for a combination of input signals, to be input to an analysis circuit, that causes transition of a level of a signal in an aggressor wire by switching a level of one input signal among input signals that determine a level of a signal in the aggressor wire influencing a victim wire that is a noise analysis target;
calculating a delay time of a transition path connecting an input terminal of the analysis circuit to which an input signal to be switched is to be input and an output terminal connected to the aggressor wire; and
generating an input vector for shifting, by a difference of a calculated delay time, switching of a level of an input signal to be input to a first transition path connected to a first aggressor wire or to a second transition path connected to a second aggressor wire included in the analysis circuit in such a manner that the levels of the signals in the first aggressor wire and the second aggressor wire transition simultaneously.

2. The design support apparatus according to claim 1, wherein
the searching executed by the processor includes
setting a same level as levels of signals before and after the transition for the first aggressor wire and the second aggressor wire, respectively, and searching, by using back tracing, for a combination of input signals to be input to the analysis circuit in such a manner that the first aggressor wire and the second aggressor wire accord with the same signal level, respectively.

3. The design support apparatus according to claim 1, wherein
the process executed by the processor further includes
dividing a circuit into partial circuits partitioned by a power source and a gate, and
forming an analysis circuit by combining a partial circuit including the victim wire and a plurality of partial circuits including aggressor wires influencing the victim wire.

4. The design support apparatus according to claim 1, wherein
the searching executed by the processor includes
searching, by using back tracing, for a combination of input signals of the analysis circuit with priority given to a level of a signal in an aggressor wire having great influence on a victim wire when there is not a combination of input signals that makes the first aggressor wire and the second aggressor wire simultaneously accord with the same signal level.

5. The design support apparatus according to claim 3, wherein
the forming executed by the processor includes
combining a partial circuit including an aggressor wire whose capacity coupling with the victim wire has a magnitude equal to or higher than a first threshold, with a partial circuit including the victim wire.

6. The design support apparatus according to claim 3, wherein
the forming executed by the processor includes
combining a partial circuit including a transistor whose drivability level is equal to or higher than a second threshold, with a partial circuit including the victim wire.

7. The design support apparatus according to claim 1, wherein
the searching executed by the processor includes
searching for a combination of input signals in such a manner that an input signal other than the input signal to be switched is fixed among input signals that are to be input to the analysis circuit.

8. The design support apparatus according to claim 1, wherein
the searching executed by the processor includes
setting a combination of input signals to be input to a logic gate included in the analysis circuit in such a manner that a level of an output signal transitions by switching a level of one input signal when the transition path is searched for by using back tracing.

9. The design support apparatus according to claim 8, wherein
the searching executed by the processor includes
setting a combination of input signals in such a manner that a level of an output signal transitions by switching a level of one input signal for a logic gate connected to a terminal of a logic gate to which the input signal to be switched is to be input.

10. The design support apparatus according to claim 8, wherein
the searching executed by the processor includes
setting a combination of input signals in such a manner that a level of an output signal is fixed for a logic gate connected to a terminal of a logic gate other than the terminal to which the input signal to be switched is to be input.

11. An input vector generation method executed by a processor executing a process, the process comprising:
searching, by using back tracing, for a combination of input signals, to be input to an analysis circuit, that causes transition of a level of a signal in an aggressor wire by switching a level of one input signal among input signals that determine a level of a signal in the aggressor wire influencing a victim wire that is a noise analysis target;
calculating a delay time of a transition path connecting an input terminal of the analysis circuit to which the input signal to be switched is to be input and an output terminal connected to the aggressor wire; and
generating an input vector that shifts, by a difference of a calculated delay time, switching of a level of an input signal to be input to a first transition path connected to a first aggressor wire or to a second transition path connected to a second aggressor wire included in the analysis circuit in such a manner that the levels of the signals in the first aggressor wire and the second aggressor wire transition simultaneously.

12. A non-transitory computer-readable recording medium having stored therein a program for causing a processor to execute a design support process, the process comprising:
searching, by using back tracing, for a combination of input signals, to be input to an analysis circuit, that causes transition of a level of a signal in an aggressor wire by switching a level of one input signal among input signals that determine a level of a signal in the aggressor wire influencing a victim wire that is a noise analysis target;
calculating a delay time of a transition path connecting an input terminal of the analysis circuit to which the input signal to be switched is to be input and an output terminal connected to the aggressor wire; and
generating an input vector that shifts, by a difference of a calculated delay time, switching of a level of an input signal to be input to a first transition path connected to a first aggressor wire or to a second transition path connected to a second aggressor wire included in the analysis circuit in such a manner that the levels of the signals in the first aggressor wire and the second aggressor wire transition simultaneously.
